(19) United States
(12) Patent Application Publication
(10) Pub. No.: US 2012/0090010 A1
(43) Pub. Date: Apr. 12, 2012

(54) SYSTEM AND METHOD FOR 360 DEGREE SITUATIONAL AWARENESS IN A MOBILE ENVIRONMENT

(75) Inventors: Glen Dace, Harvest, AL (US); John Richards, Union Grove, AL (US); Kevin Belue, Athens, AL (US); Brian Rector, Huntsville, AL (US)

(73) Assignee: DRS TEST & ENERGY MANAGEMENT, LLC, Huntsville, AL (US)

(21) Appl. No.: 13/327,391

(22) Filed: Dec. 15, 2011

Related U.S. Application Data
(63) Continuation of application No. PCT/US2010/039143, filed on Jun. 18, 2010.
(60) Provisional application No. 61/218,329, filed on Jun. 18, 2009.

(51) Int. Cl. H04N 7/18

(52) U.S. Cl. 725/75; 348/148; 348/144; 348/E07.085

(57) ABSTRACT

A method for providing situational awareness for a transport vehicle includes receiving a plurality of sensory inputs from cameras positioned about the periphery of the transport vehicle and processing the plurality of sensory inputs to generate a plurality of processed signals for display to one or more displays. The method also includes receiving user input from distinct users specifying one or more views to display on each of the one or more displays as received and processed from the plurality of sensory inputs and communicating the plurality of processed signals for displaying the one or more views on each of the one or more displays in response to receiving the user input.

### CROSS-REFERENCES TO RELATED APPLICATIONS

This application claims priority to and is a continuation of International Patent Application No. PCT/US2010/039143, filed on Jun. 18, 2010, which claims the benefit of U.S. Provisional Application No. 61/218,329, filed Jun. 18, 2009, the disclosures of which are hereby incorporated by reference in their entirety.

### BACKGROUND OF THE INVENTION

In many regions of the world, stability has been decreasing in recent years. As a result, military personnel, politicians, contractors, and other civilians need to be situationally aware when traveling between destinations or points. Situational awareness is commonly defined as the perception of environmental elements within an area or space for a time period and the projection of status for the area in space in the near future. With military personnel, situational awareness involves being aware of what is happening in their environment to understand how information, events, and actions, will impact specified goals and objectives.

In many cases, being situationally aware allows military personnel to protect themselves and others from any number of threats or risks. In many cases, systems and devices designed to facilitate situational awareness are complicated, messy, temperature and environmentally limited, have limited compatibility with input devices, and are power hungry. As a result, there is a need for simplified and stable systems that address the numerous user and rugged environmental concerns to enhance situational awareness.

### SUMMARY OF THE INVENTION

One embodiment provides a system and method for providing situational awareness for a transport vehicle. A number of sensory inputs may be received from cameras positioned about the periphery of the transport vehicle. The number of sensory inputs may be processed to generate a number of processed signals for display to one or more displays. User input may be received from distinct users specifying one or more views to display on each of the one or more displays as received and processed from the number of sensory inputs. The number of processed signals may be communicated for displaying the one or more views on each of the one or more displays in response to receiving the user input.

Another embodiment includes a video and data distribution system (VDDS) for a transport vehicle. The system may include a number of input ports operable to receive input signals from a number of sensory devices about the periphery of the transport vehicle. The system may also include processing logic in communication with the number of input ports. The number of input ports may be operable to process the input signals to generate formatted signals displayable to a number of displays. The formatted signals may include a number of views associated with each of the sensor} 7 devices. The system may also include a user interface in communication with the processing logic. The user interface may be utilized by a number of users utilizing the number of displays to select the number of views displayed to each of the number of displays and overlay information. The system may also include a number of output ports in communication with the processing logic. The number of output ports may be operable to communicate the formatted signals to the number of displays. The system may also include a number of pass-thru channels operable to communicate data from the one or more of the sensory devices to one or more of the plurality of displays in the event the VDDS fails.

Yet another embodiment provides a VDDS for a transport vehicle. The system may include a number of input ports operable to receive input signals from a number of sensory devices about the periphery of the transport vehicle, the number of input ports operable to receive phase PAL A, PAL B, NTSC, RS-343, RS-170, SECAM, different RGB resolutions video graphics array (VGA), SVGA, and XVGA, digital visual format (DVI), video over Internet Protocol (IP), and S video. The system may further include processing logic operable to process the input signals to generate formatted signals displayable to a number of displays. The system may further include a number of output ports operable to communicate the formatted signals compatible with the plurality of displays. A first user may access a first of the number of displays to select a number of views to be displayed on the first of the number of displays accessible to the user. A second user may access a second of the number of displays to select a number of views to be displayed on the second of the number of displays. The system may further include a number of pass-thru channels operable to communicate information from one or more of the sensory devices to one or more of the number of displays in the event the VDDS fails. The system may further include a memory card interface operable to receive a memory card for implementing software configurations of the VDDS and training scenarios in the transport vehicle as if the training scenarios were occurring in real time.

### BRIEF DESCRIPTION OF THE DRAWINGS

Illustrative embodiments of the present disclosure are described in detail below with reference to the attached drawing figures, which are incorporated by reference herein and wherein:

FIG. 1 is a pictorial representation of a transport vehicle in an operational environment in accordance with an illustrative embodiment;

FIG. 2 is a pictorial representation of an interconnected VDDS system in accordance with an illustrative embodiment;

FIG. 3 is a block diagram of external interfaces of a VDDS system in accordance with illustrative embodiments;

FIG. 4 is a block diagram of portions of a VDDS in accordance with an illustrative embodiment;

FIG. 5 is a block diagram of a management processor system in accordance with an illustrative embodiment;

FIG. 6 is a block diagram of a video processor system in accordance with an illustrative embodiment;

FIG. 7 is a flowchart of an exemplary process for user interactions with a VDDS in accordance with an illustrative embodiment;

FIG. 8 is a flowchart of an exemplary process for processing data in accordance with an illustrative embodiment;

FIG. 9 is a pictorial representation of a VDDS menu for driving a transport vehicle in accordance with an illustrative embodiment;

FIG. 10 is a pictorial representation of a VDDS menu for driving a transport vehicle in reverse in accordance with an illustrative embodiment;

FIG. 11 is a pictorial representation of a VDDS menu for toggling and displaying selection elements in accordance with an illustrative embodiment;

FIG. 12 is a pictorial representation of a VDDS menu for camera control in accordance with an illustrative embodiment; and

FIG. 13 is a pictorial representation of a VDDS menu for camera selection in accordance with an illustrative embodiment.

### DETAILED DESCRIPTION OF SPECIFIC EMBODIMENTS

The illustrative embodiments of the present disclosure provide a system, method, and stand-alone device, enabling situational awareness in mobile environments. In one embodiment, a video/data distribution system (VDDS) may be ruggedized and configured to operate in harsh environments frequently faced by various transport vehicles.

The VDDS is configured to be operational in a temperature range of −40 to 71 degrees Celsius. The VDDS may also be watertight in 1.0 m of water for 30 minutes, endure high humidity 95%+/−5% Non Condensing 60 degrees C., shock of 30G for 1 1 ms half sine for all 6 axis, vibration per Military Standard (Mil-Std) 810F, and is salt, sand, and fungus resistant. The various electrical connections are similarly waterproof and corrosion resistant. For marketing and production purposes, one embodiment of the VDDS may also be referred to as OmniScape™

The VDDS is operable to receive input from various cameras and sensors utilizing numerous formats and standards. The analog and/or digital inputs are digitized, processed, reformatted, and distributed in a form compatible with multiple displays available within a transport vehicle in which the VDDS is being utilized. The VDDS may be controlled by multiple users/viewers simultaneously utilizing respective displays and interfaces.

The input, outputs, busses, processor and memory of the VDDS allow the system to be customizable and configurable for any number of transport vehicles and uses. For example, software modules or packages may be installed to customize the VDDS for use by various units of the armed forces including the Army, Navy, Air Force, Marines, or Coast Guard or for specific civilian organizations.

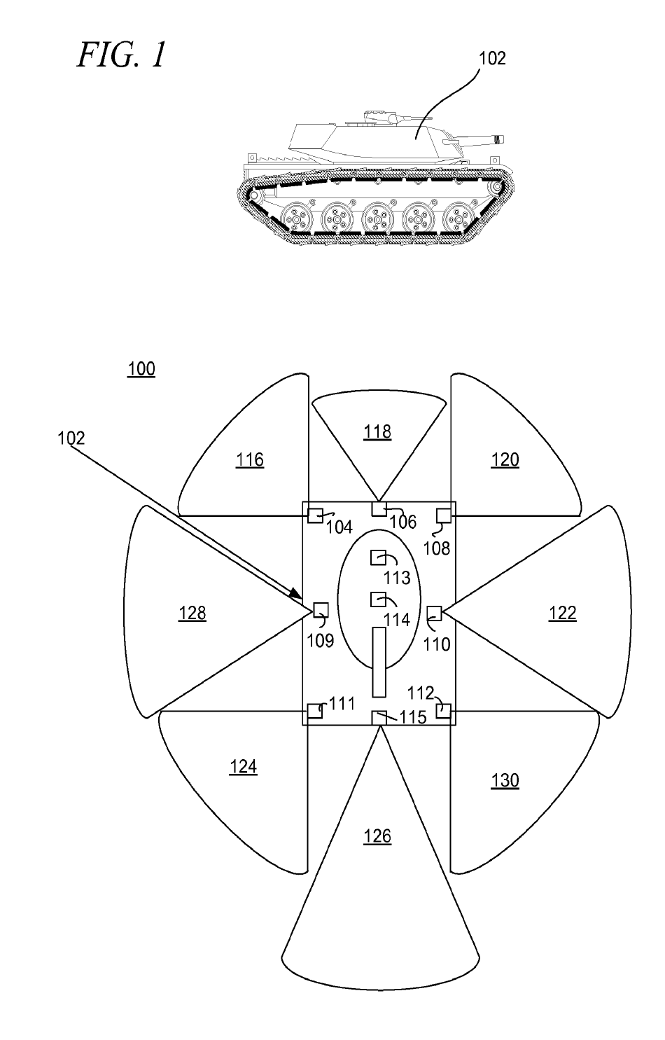

FIG. 1 is a pictorial representation of a transport vehicle in an operational environment in accordance with an illustrative embodiment. FIG. 1 shows one embodiment of an operational environment 100 and a transport vehicle 102 operating in the operational environment 100. The transport vehicle 102 may further include cameras 104, 106, 108, 109, 110, 111, 112, 113, 114, and 115 and corresponding fields 116, 118, 120, 122, 124, 126, 128, and 130.

The operational environment 100 represents any number of environments in which the transport vehicle 102 may operate. The operational environment 100 may represent standard civilian environments, such as roads, streets, highways, and outdoor areas. The operational environment 100 may also represent military environments, such as training, fields, threat environments, and battle environments.

In one embodiment, the transport vehicle 102 is a tank as shown in FIG. 1. However, the transport vehicle 102 may be any transportation element suitable for transporting individuals or goods from one location to another. For example, the transport vehicle 102 may be a standard passenger car, armored vehicle, Bradley vehicle, Humvee, High Mobility Multipurpose Wheeled Vehicle (HMMWV), multiple rocket launcher, Howitzer, truck, boat, train, amphibious vehicle, personnel carrier, plane, or other mobile device. In another embodiment, the transport vehicle 102 may be an autonomous-unmanned vehicle or drone that transmits data, images, and information captured by the cameras 104, 106, 108, 109, 110, 111, 112, 113, 114, and 115 and the equipment of the transport vehicle 102 to one or more remote locations. In particular, the transport vehicle 102 may lack visibility and as a result the occupants and other users may rely on the cameras 104, 106, 108, 109, 110, 111, 112, 113, 114, and 115 for critical information.

The transport vehicle 102 includes a plurality of sensory devices. The sensory devices are input, signal, information, data, and image capture devices or elements. In one embodiment, the sensory inputs include cameras 104, 106, 108, 109, 110, 111, 112, 113, 114, and 115 which may be sensory and image capture devices. The cameras 104, 106, 108, 109, 110, 111, 112, 113, 114, and 115 may include any European or American video formats such as PAL A, PAL B, RS 170, RS 343, NTSC, RGB (resolution up to XVGA), S Video, DVI, video over Internet Protocol (IP) still-image cameras, motion detectors, infrared cameras, thermal imaging system (TIS), X-rays, telescopes, range finders, targeting equipment, navigation systems, ultraviolet cameras, night vision, and other camera types that utilize standard video input/output (I/O) methods.

In one embodiment, the cameras 104, 106, 108, 109, 110, 111, 112, 113, 114, and 115 may be retrofitted or mounted to the transport vehicle 102 or may be integrated with the vehicle. In another embodiment, the cameras 104, 106, 108, 109, 110, 111, 112, 113, 114, and 115 are integrated with the body materials of the transport vehicle 102 for enhanced stability and protection. In one embodiment, The transport vehicle 102 may utilize up to 21 cameras or other sensors that provide input to the VDDS within the transport vehicle 102. The number of cameras or sensors may vary based on the hardware that supports such inputs in the VDDS. For example, cameras 104, 106, 108, 109, 110, 111, 112, 113, 114, and 115 may include multiple cameras or functions allowing for simultaneous nighttime and infrared viewing.

The fields 116, 118, 120, 122, 124, 126, 128, and 130 are the fields of view of the corresponding cameras 104, 106, 108, 109, 110, 111, and 112. The fields 116, 118, 120, 122, 124, 126, 128, and 130 may take on any number of shapes and configurations. For example, the range of each camera 104, 106, 108, 109, 110, 111, 112, 113, 114, and 115 may vary based on the conditions and configuration of the operational environment as well as the technical abilities of the cameras 104, 106, 108, 109, 110, 111, 112, 113, 114, and 115. For example, a night vision camera is likely to have a decreased range when compared with a day-time camera.

In one embodiment, the VDDS may be configured to perform any number of remote capture and control features. For example, the fields 116, 118, 120, 122, 124, 126, 128, and 130 may be communicated to one or more remote locations, such as a field office to provide additional review or analysis by more users or systems. Additional information may be communicated directly from the VDDS or utilizing additional wireless or other communications systems that may be utilized within the transport vehicle 102. In another embodiment, a remote location may utilize the interfaces to control the cameras 104, 106, 108, 109, 110, 111, 112, 113, 114, and 115 or other systems of the VDDS to provide help and support. For example, based on satellite intelligence a remote user may work with a user in the transport vehicle 102 to direct camera 108 and 109 to a suspected threat. Alternatively, the remote user may adjust the gain and polarity of the camera 108 to further facilitate a user viewing the display and field 120. The remote user may take direct control of the cameras 108 and 109 or may utilize overlay features to further indicate or show information to the user. As a result, remote parties and devices may communicate with the VDDS within the transport vehicle 102 to provide additional support and assistance to the individuals in the transport vehicle 102.

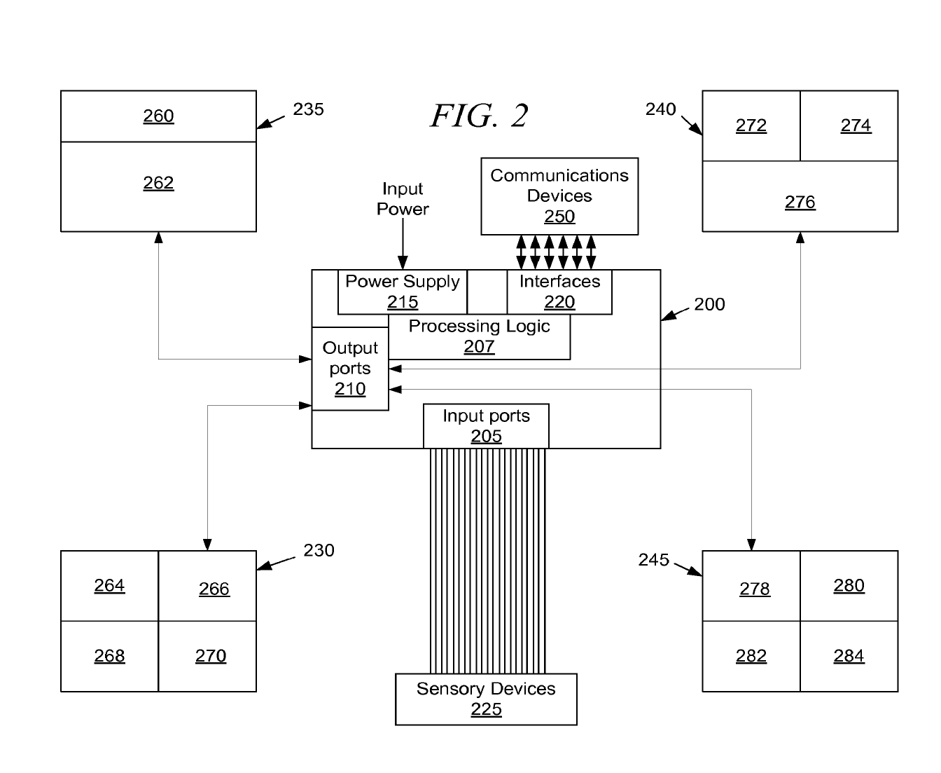

FIG. 2 is a pictorial representation of an interconnected VDDS 200 in accordance with an illustrative embodiment. The VDDS 200 in a particular implementation of a device that may be utilized in the operational environment 100 of FIG. 1. The elements of FIG. 2 may represent portions of a situational awareness system that may be operated or integrated internal and/or external to a transport vehicle. In one embodiment, the VDDS 200 may be a single stand-alone device. The VDDS 200 may be used in various transport vehicles and as a result is mobile and built for rugged environments. For example, the VDDS 200 may weigh approximately 20 pounds and may be utilized in multiple transport vehicles by interconnecting, various peripheral sensory devices, power sources, displays, and other interfaces.

The components of the VDDS 200 are housed in a chassis. The chassis allows the other elements to be mounted and positioned for enhancing heating, cooling (heat dissipation), and preventing various forms of mechanical, electrical, and environmental trauma that the VDDS 200 may experience. In one embodiment, the chassis is a conduction cooled aluminum chassis with fins on multiple sides that is able to dissipate 50 Watts of energy generated by the video processing and circuitry of the VDDS 200.

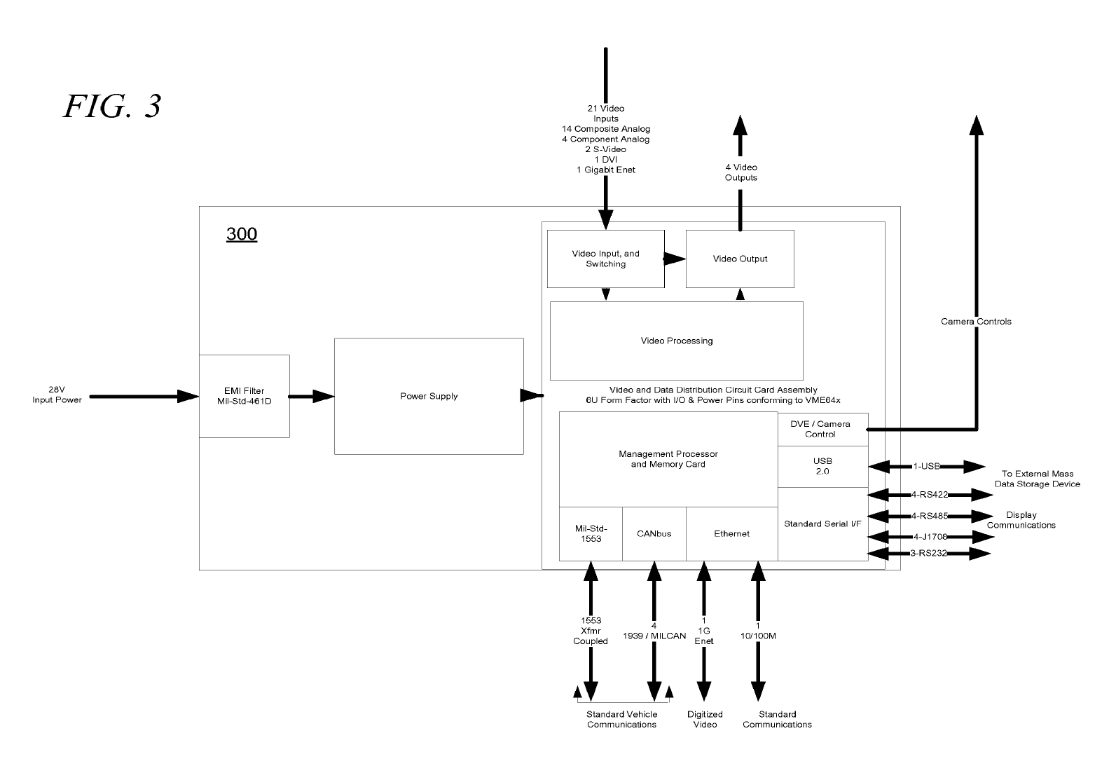

The VDDS 200 may include any number of computing and communications hardware, firmware, and software elements, devices, and modules not specifically shown herein, for purposes of simplicity, which may include busses, motherboards, circuits, ports, interfaces, cards, converters, adapters, connections, transceivers, displays, antennas, and other similar components as further illustrated in FIGS. 3-5. In one embodiment, the VDDS 200 may include input ports 205, processing logic 207, output ports 210, a power supply 215, and interfaces 220. The VDDS 200 may further communicate with sensory devices 225, displays 230, 235, 240, and 245, and communications devices 250. The displays 230, 235, 240, and 245 may further display views 260, 262, 264, 266, 268, 270, 272, 274, 276, 278, 280, 282, and 284.

In one embodiment, the VDDS 200 and corresponding peripheral elements are interconnected in a star architecture. In another embodiment, the various peripherals may be interconnected utilizing other architectures. A number of adapters, splitters, or power supplies and other elements may be utilized with the peripherals, even though not explicidy shown herein.

The input ports 205 are the hardware interfaces for communicating with the sensory devices 225. The input ports 205 may communicate with the sensory devices 225 through any number of cables, fiber optics, wires, or other electronic signaling mediums. The sensory devices 225 are a particular implementation of the cameras 104, 106, 108, 109, 110, 111, 112, 113, 114, and 115 of FIG. 1. The input ports 205 may include circuitry and software for accepting any number of formats and standards including composite analog formats, such as phase alternating line (PAL) A, PAL B, National Television System Committee (NTSC), RS-343, RS-170, red, green, blue formats, such as video graphics array (VGA), super video graphics array (SVGA), XVGA, digital visual format DVI, video over Internet Protocol (IP), and S video (any equipment that has a video or digital output). In one embodiment, the VDDS 200 may be operable to receive input from up to twenty-one different sensory devices simultaneously.

The input ports 205 or processing logic 207 may also include control logic for automatically or manually controlling the sensory devices 225. For example, a number of night vision or infrared cameras may be directionally controlled either automatically or manually. The camera control may also control elements, such as gain, level, and polarity that make the image clearer in critical conditions.

The output ports 210 are the hardware interfaces for communicating with the displays 230, 235, 240, and 245. The output ports 210 may also be configured to utilize the analog, digital and eight channels of video over IP standards utilized by the input ports 205.

The displays 230, 235, 240, and 245 are visual presentation devices for displaying images, text, data, and other information. In one embodiment, each display may represent a crew station of a crew member within the vehicle. For example, each member of a crew in a transport vehicle may have an assignment, such as driving, navigation, weapons, and threat monitoring. As a result, each of the displays may show any of the available video feeds or inputs including the views 260, 262, 264, 266, 268, 270, 272, 274, 276, 278, 280, 282, and 284 regardless of what the other crew members are viewing. The user may also select a quadrant or location of the one or more views displayed by each of the displays 230, 235, 240, and 245 based on personal preferences, assignments, and needs. As a result, each display may provide the user or collective users a 360° view of the transport vehicle. Each user may also select overlay information, such as speed, direction, location, mirrors, windows, vehicle status, or vehicle performance.

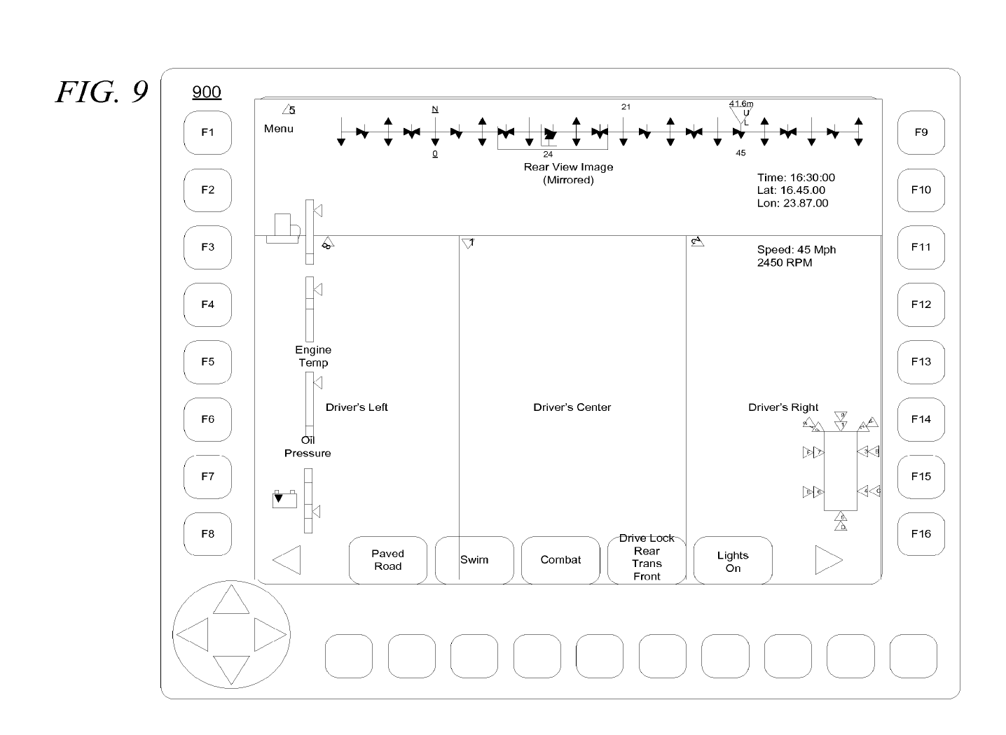

The displays 230, 235, 240, and 245 may include smart or dumb devices that interface with the VDDS 200. A smart device may be operable to select input from the sensory devices 225 without a menu displayed by the VDDS 200. For example, the display 230 may be a smart device, such as a laptop operating in an Ml tank from which a user may select to display the views 264, 266, 268, and 270. In another embodiment, the display 235 may be a dumb device, such as a touch screen monitor operated in a military rail vehicle. The VDDS 200 may communicate a menu and options to the display 235 in order to receive user input, selections, and feedback selecting, for example to display the views 260 and 262. FIGS. 9-13 further illustrate various displays and menu configurations.

The power supply 215 of FIG. 2 is the interface and circuitry operable to receive an electrical connection for powering the VDDS 200. The power supply 215 may include one or more devices or elements for limiting electromagnetic interference (EMI) as well as a heater for heating the chassis and components of the VDDS 200 in cold environments. In one embodiment, the power supply 215 may be powered by a 28 V power source and may only require 29 Watts of power to perform the various features and processes herein described. Alternative voltages and wattages may be utilized based on the nature of the hardware.

The interfaces 220 are additional interfaces for communicating information to and from the VDDS 200. In one embodiment, the interfaces 220 may communicate with communications devices 250. The interfaces 220 may include a memory card interface for receiving one or more memory cards. Training scenarios may be stored on the memory card and the still or video images, threats, and conditions associated with images of the memory card may be output by the VDDS 200 as if received by the input ports 205 from the sensory devices 225. Training scenarios may be uploaded remotely, further enhancing the usefulness of the VDDS 200.

The input ports 205, output ports 210, power supply 215, and interfaces 220 may utilize any number of connectors including 2-128 pin signal connectors, 4 pin power connectors, 85 pin DVI, In/Out & USB connector, and 2-10 Pin Gigabit Ethernet Connectors.

The processing logic 207 is the logic, circuitry and elements operable to format the information received from the sensory devices 225 for output to the displays 235, 240, 245, and 250. The processing logic 207 is also operable to manage the processes, features, and steps performed by the VDDS 200. The processing logic 207 may include one or more processors and memory elements. In one embodiment, the processing logic 207 may include multiple network processors to manage the processing of video images and the other processes herein described. For example, one processor may execute a Linux kernel and manage the processes of multiple video processors. Any number of drivers and algorithms may be implemented or executed for each FPGA, HPI, CAN Bus, camera control, multiplexers, decoders, and other similar elements. In one embodiment, the VDDS 200 may include a number of libraries that may correspond to a vehicle type and configuration. During a setup phase, one or more users may install or load the library corresponding to the vehicle type and configuration in order to enable the VDDS 200 for operation.

The processor is circuitry or logic enabled to control execution of a set of instructions. The processor may be microprocessors, digital signal processors, field programmable gate array (FPGA), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory is a hardware element, device, or recording media configured to store data for subsequent retrieval or access at a later time. The memory may be static or dynamic memory. The memory may include a hard disk, random access memory, cache, removable media drive, mass storage, or configuration suitable as storage for data, instructions, and information. In one embodiment, the memory and processor may be integrated. The memory may use any type of volatile or non-volatile storage techniques and mediums. In one embodiment, non-volatile memory may be available to each component of the VDDS 200. The memory may store information and details in order to provide black box readings regarding the transport vehicle, systems, environmental conditions, or other factors. For example, ten minutes of data may be archived at all times before a failure or detection of a catastrophic event. The memory may also store input from all cameras for a certain time period (such as seconds, minutes, hours, or days) so that the images and events may be recreated at a later time or date, played back, or integrated into a training scenario. Recorded training scenarios may be especially useful because they allow recreation of actual events in a format that was actually seen from a transport vehicle during operations. For example, some vehicles may rely primarily on electronic viewing during travel and as a result recorded scenarios may closely mimic real conditions for training, live-fire exercises, and becoming accustomed to the VDDS 200.

In another embodiment, the VDDS 200 may execute the Linux operating system as software that controls the execution of applications and the processing of various data and video streams received by the VDDS 200. A video interface of the VDDS may be connected or looped back to the video processor card for performing self-tests.

FIG. 3 is a block diagram of external interfaces of a VDDS 300 in accordance with illustrative embodiments. The block diagram of FIG. 3 is a particular implementation of the VDDS 200 of FIG. 2. The VDDS 300 allows for simultaneous capture of 16 or more video inputs. In the illustrative embodiment shown, the video inputs includes 14 composite, 2 S-video, 4 component, 1 DVI, and 1 Gb. The video outputs include the same available outputs, 1 DVI, and 1 Gb. Each of the outputs is capable of displaying up to four of the available video inputs at any time.

There may be a number of analog video types supported as previously described including composite interlaced, such as NTSC, PAL, SECAM, and S-video, progressive scan, such as computer graphics RGB (external hsync/vsync and sync on green) up to XGA and YPbPr, and thermal imaging systems. The VDDS 300 may also support digital video types, such as DVI and Gigabit Ethernet. The VDDS 300 may include three channels with a feed-thru capability for target acquisition systems, navigation systems, and other critical streams. The feed-thru channels may still function to communicate data, signals, and streams even if all or a portion of the VDDS 300 fails or experiences severe errors.

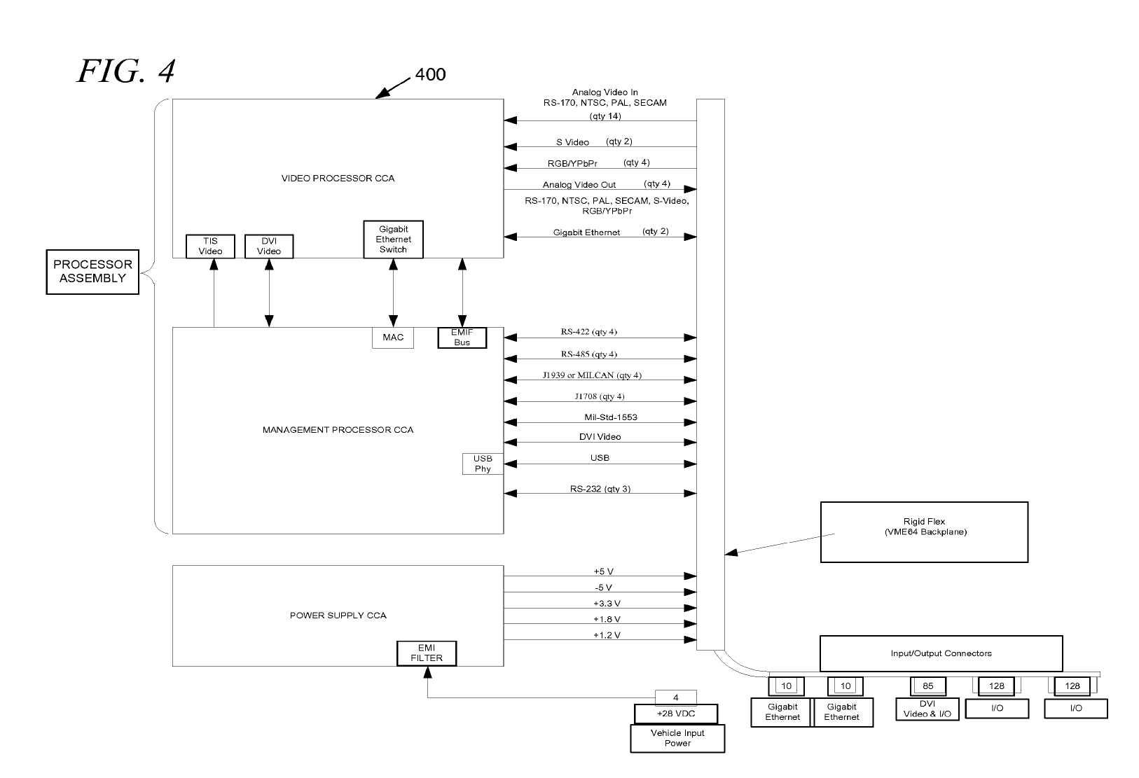

FIG. 4 is a block diagram of portions of a VDDS 400 in accordance with an illustrative embodiment. The VDDS 400 further illustrates the various interfaces and connections between the components of the VDDS including processors, a power supply, backplane, input/output connectors, and other elements.

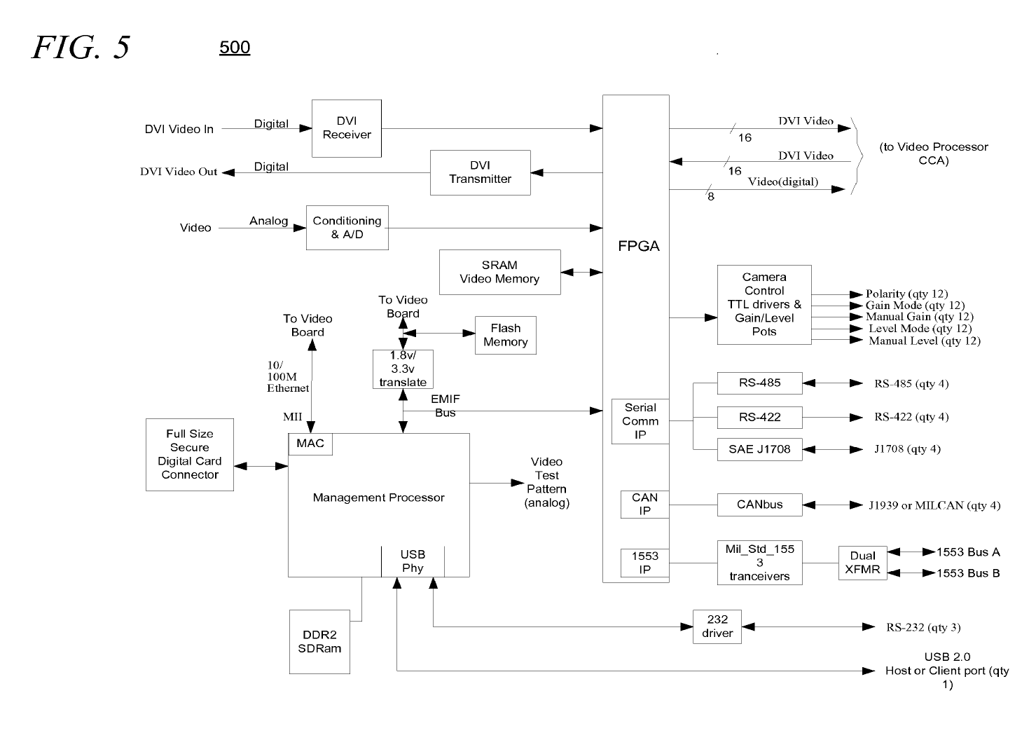

FIG. 5 is a block diagram of a management processor system 500 in accordance with an illustrative embodiment. The management processor system includes a number of components that may be purchased off the shelf or implemented based on a custom configuration. The management processor system 500 and video processor system of FIG. 5 may include a number of receivers, transmitters, analog-to-digital converters, digital-to-analog converters, memories, decoders, busses, card connectors, buffers, multiplexers, processors, memories, switches, and interfaces, FPGAs, and interface ports compatible with the standards, connections, and protocols herein described. In one embodiment, the FPGAs may be individually programmed for implementing the processes and features herein described.

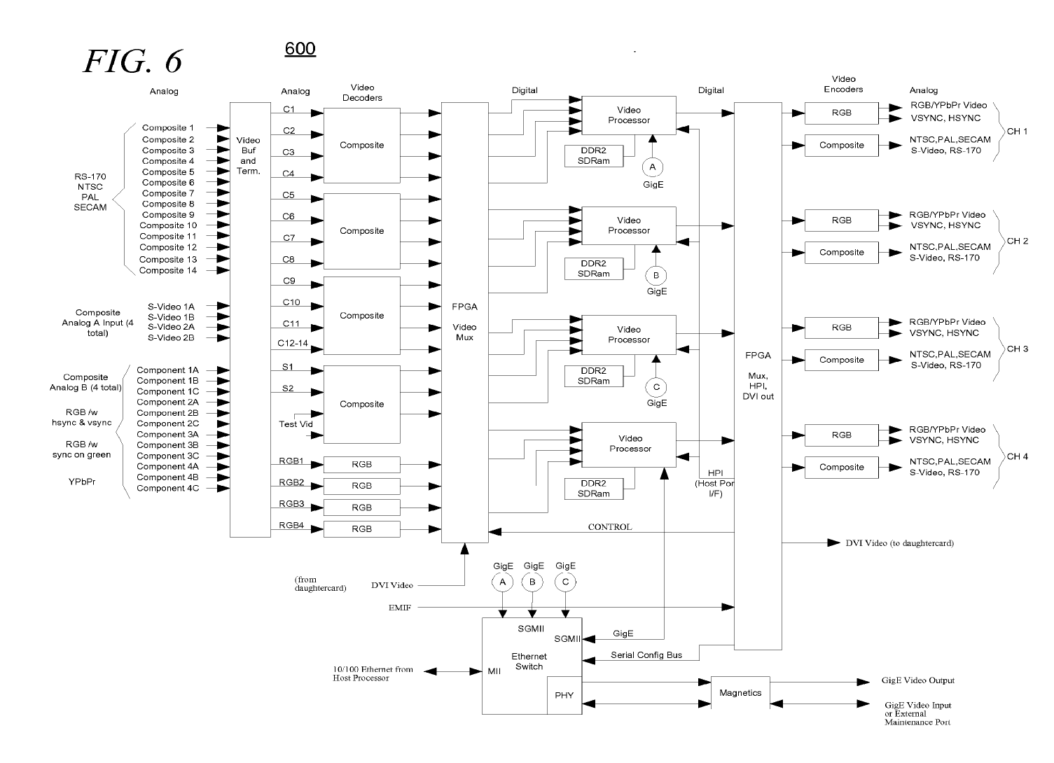

FIG. 6 is a block diagram of a video processor system 600 in accordance with an illustrative embodiment. The video processor system 600 further illustrates elements and communications that may occur within the VDDS. The video processor system 600 may utilize any number of customizable elements as well as some off-the-shelf devices, systems, and components

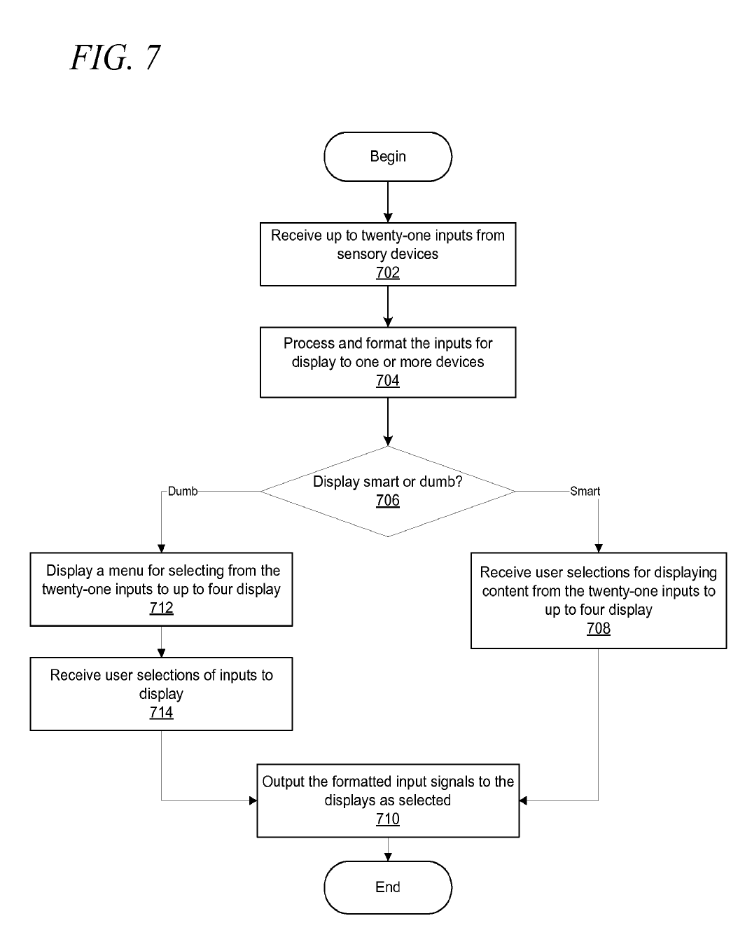

FIG. 7 is a flowchart of an exemplar} 7 process for user interactions with a VDDS in accordance with an illustrative embodiment. The process of FIG. 7 may be implemented by a VDDS in accordance with an illustrative embodiment. The process may begin by receiving up to twenty-one inputs from sensory devices (step 702). The sensory devices may include cameras, thermal sensors, infrared imagers, night vision observations, and other similar sensory devices.

Next, the VDDS processes and formats the inputs for display to one or more devices (step 704). In one embodiment, the VDDS may communicate with up to four displays.

The VDDS determines whether a display is smart or dumb (step 706). In one embodiment, a display may be determined to be smart if the user may navigate the available outputs or data streams of the VDDS without additional feedback or help. The determination may be determined automatically or based on a user selection of a connected device.

In response to determining whether the VDDS is smart, the VDDS receives user selections for displaying content from the twenty-one inputs to up to four displays (step 708).

The user may provide input or selections by selecting icons, utilizing one or more thumb controllers, voice commands, text commands, or other input.

Next, the VDDS outputs the formatted input signals to the displays as selected (step 710). In one embodiment, the user may overlay views and information or display up to four views simultaneously. The size and shape of the views may be based on selections by the user. For example, the user may configure a display to mimic a front window of a vehicle and a rear view mirror even if the transport vehicle does not have windows because of necessary shielding and security.

In response to determining the display is dumb in step 706, the VDDS displays a menu for selection from the twenty-one inputs to up to four displays (step 712). The VDDS may display the menu because the display is incapable of selecting between the different views utilizing the device alone.

Next, the VDDS receives user selections of inputs to display (step 714). For example, the user selections may be received based on touch selections utilizing a touch screen. The process of FIG. 7 may be implemented simultaneously for multiple displays.

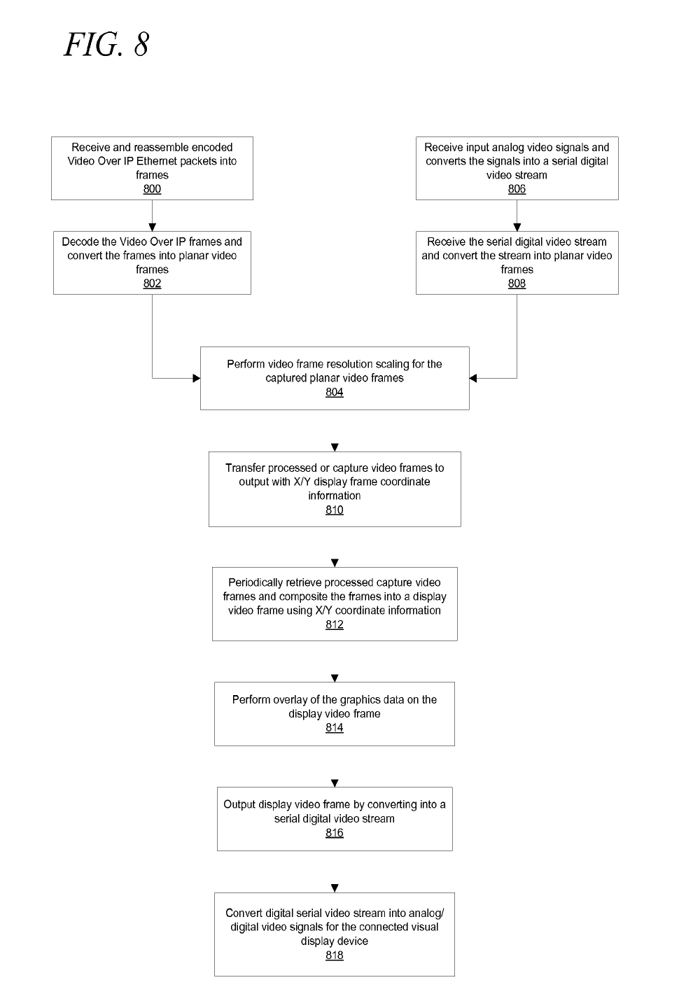

FIG. 8 is a flowchart of an exemplary process for processing data in accordance with an illustrative embodiment. The process of FIG. 8 may be implemented by a VDDS that is operable to interact with users, a video hub, and a routing controller for providing situational awareness to a vehicle or transport device, such as a combat vehicle. The VDDS is operable to collect, digitize, process, reformat and distribute video and data in the form needed by nearly any applicable display.

The process of FIG. 8 may begin by receiving and reassembling encoded video over IP Ethernet packets into frames (step 800). The VDDS may receive a number of different incoming inputs or data streams including video over IP. The packets may be received and reassembled prior to performing any video processing. The frames may be encoded utilizing parameters, such as number of pixels, refresh rate, or other characteristics or parameters of the incoming data stream.

Next, the VDDS decodes the video over IP frames and converts the frames into planar video frames (step 802). The planar video frames may be more easily processed and formatted by the VDDS. The VDDS performs video frame resolution scaling for the captured planar video frames (step 804). During step 804, scaling may be performed to allow multiple views to be displayed simultaneously to each display. The scaling may be performed based on default selections, automatic configurations, or user selections of inputs for display.

Simultaneously, the VDDS receives analog video signals and converts the signals into a digital video stream (step 806). In one embodiment, one or more encoders/decoders may digitize the analog signals received from various cameras and sensory devices based on parameters of the analog video signals. The DDS receives the serial digital video stream and converts the stream into planar video frames (step 806). By converting the different incoming signals and streams into the planar video frames, the varying types of incoming streams may be more efficiently processed.

The DDS performs video frame resolution scaling for the captured planar video frames (step 804). In one embodiment, the scaling may be performed utilizing a 4:2:2 planar video frame as the parameter. During step 804, the video frames may also be further processed and formatted for subsequent display. Other developing forms of scaling and interleaving may also be utilized.

Next, the VDDS transfers processed or capture video frames to output with X/Y display frame coordinate information (step 810). The X/Y coordinates may allow VDDS to display the various video, images, information, and text in any number of quadrants or positions of the display. The X/Y may limit the location in which a particular stream may be displayed. For example, one digital stream may be constrained to a right bottom corner of the screen. In another embodiment, the video may need to be scaled up and positioned for display to an entire flat panel touch screen.

Next, the VDDS periodically retrieves processed capture video frames and composites the frames into a display video frame using the X/Y coordinate information (step 812). The different frames may be composited for display according to user selections and technical characteristics of the display.

Next, the VDDS performs overlay of the graphics data on the display video frame (step 814). In one embodiment, the VDDS may overlay one or more input sources. For example, data and images from a night vision camera and the TIS may be overlaid to provide a more useful picture for nighttime operations. In another embodiment, the speed of a vehicle, GPS coordinates, vehicle status, maps including latitude and longitude, threat assessments, targeting information, operation and network information, objectives, time, available fuel, and engine revolutions per minute may be overlaid on the display video frame. Each individual display and user may display different overlays for monitoring different information that may enable the user to perform their respective tasks, assignments, and duties.

Next, the VDDS outputs digital video frame by converting into a serial digital video stream (816). The VDDS converts the serial digital video stream into analog/digital video signals for the connected visual display devices (step 818). The serial video stream may be converted to analog and digital video streams according to various parameters and based on the configuration of the VDDS and interconnected displays.

FIG. 9 is a pictorial representation of a VDDS menu for driving a transport vehicle in accordance with an illustrative embodiment. FIG. 9 illustrates one embodiment of a display 900. The displays of FIGS. 9-13 are a particular implementation of displays 230, 235, 240, and 245 of FIG. 2. FIGS. 9-12 may be displayed by the VDDS.

The displays may include any number of menus, drop down lists, indicators, icons, selection elements, toggle devices data, text, targeting information, position and directional details, and other similar information. The display 900 may be a smart device or a dumb device. For example, the various indicators may be implemented on a touch screen based on a menu driver implemented by the VDDS. In another embodiment, the indicators may be hard buttons or soft keys that are integrated with the display 900.

The display 900 may provide a number of views. For example, in FIG. 9 the display may represent forward driving in an armored amphibious vehicle. The display 900 may be configured to show a forward, left, right, and rear view. Similarly, other camera views may be selected utilizing any number of indicators. The display 900 may show the camera views as well as a number of overlaid information. The overlaid information may include available fuel, engine temperature, pressure, battery charge, transmission speed, GPS information, maps, speed, direction, and VDDS mode.

The user may control and access systems of the VDDS and vehicle by selecting indicators. The user may utilize icons, touch screens, a keyboard, mouse, trackball, joystick, or other interface methods or systems to interact with the display 900.

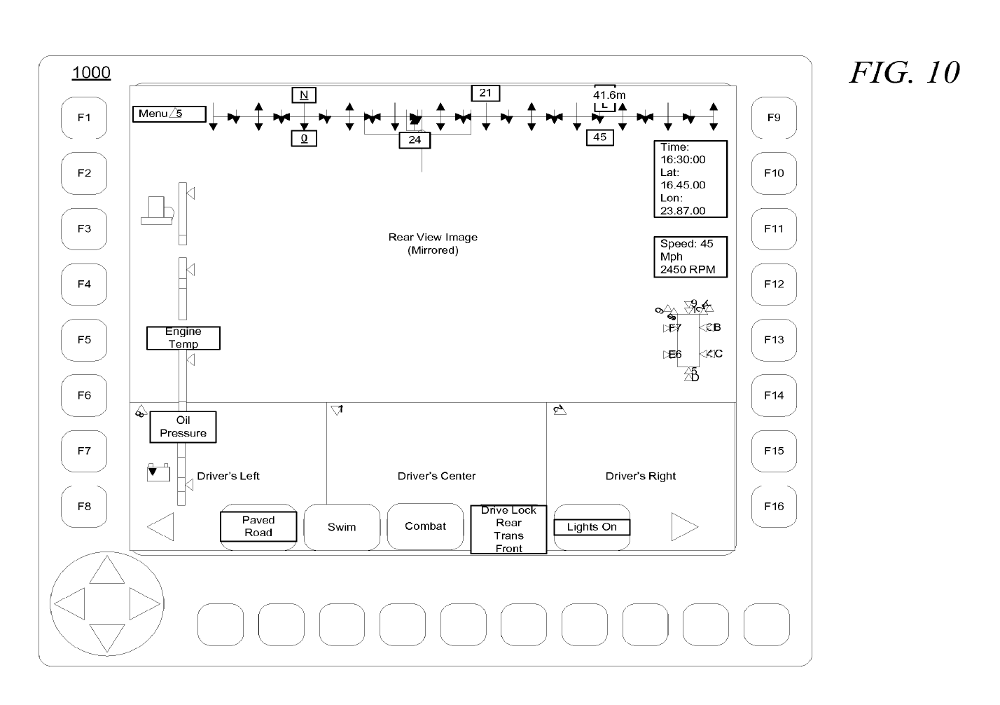

FIG. 10 is a pictorial representation of a VDDS menu for driving a transport vehicle in reverse in accordance with an illustrative embodiment. FIG. 10 illustrates a display 1000 for driving in reverse. The rear view image may be increased in size to allow the driver or other user to more effectively drive or manipulate a vehicle, such as a tank. In one embodiment, the VDDS may automatically switch between views based on conditions. For example, by changing from drive to reverse the display 1000 may reconfigure itself from the display 900 of FIG. 9 to the display 1000 of FIG. 10. Similarly, activating a weapons system may display more overlays relating to targeting in response to a user selection or radar detecting unknown vehicles approaching the tank.

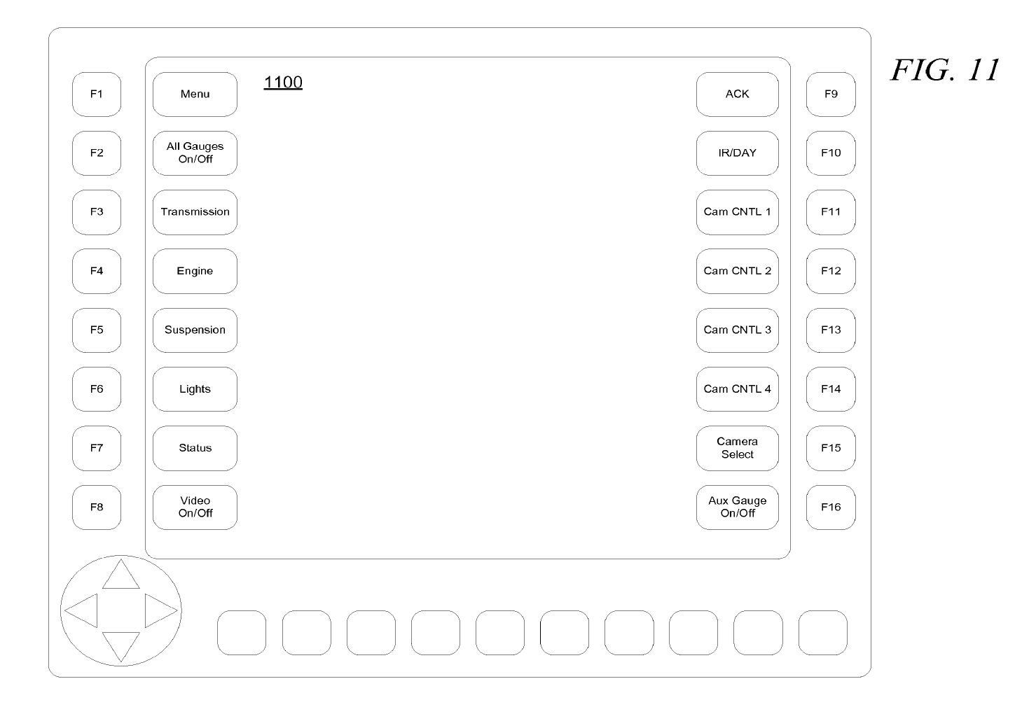

FIG. 11 is a pictorial representation of a VDDS menu for toggling and displaying selection elements in accordance with an illustrative embodiment. FIG. 11 illustrates a display 1100 that may be utilized for selecting views, overlays, and other menu elements for toggling between graphical and video selections.

The user may utilize the display 1100 to toggle between a main menu and a driving screen. The user may also select gauges and indicators and portions or quadrants of the screen on which to display the information. In one embodiment, a touch screen may allow a user to drag-and-drop selections and effectively interact with the different systems managed by the VDDS. For example, displayed information and views may be configured by dragging and dropping utilizing a touch screen or based on other user input. The display 1100 may also allowT a user to toggle video on and off as well as infrared and daytime cameras.

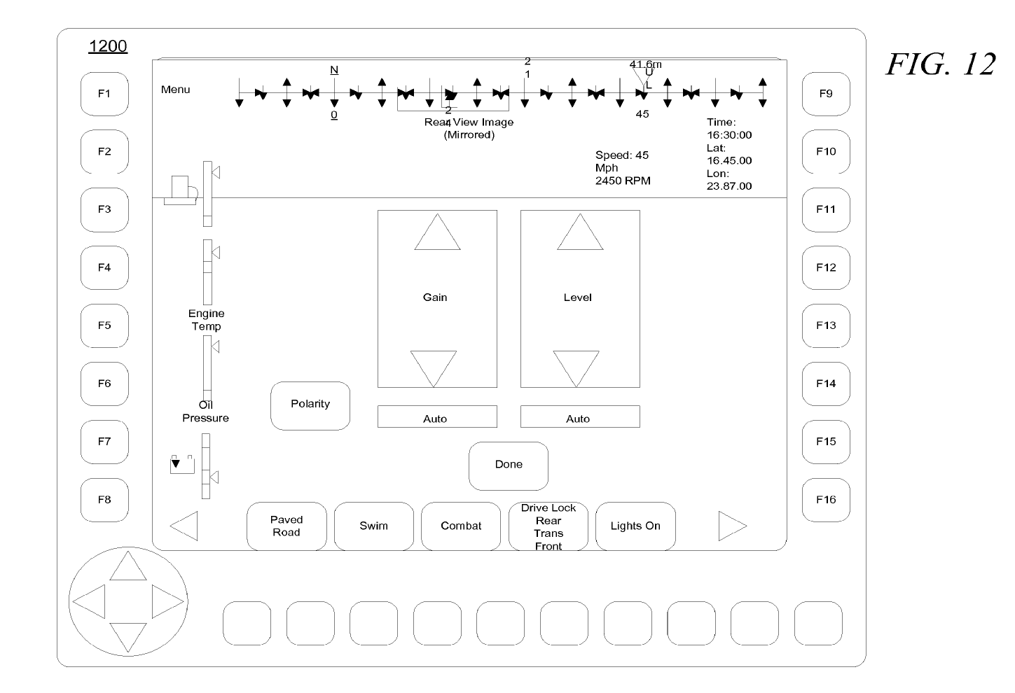

FIG. 12 is a pictorial representation of a VDDS menu for camera control in accordance with an illustrative embodiment. FIG. 12 illustrates a display 1200 and corresponding menu that may be utilized to control various cameras and sensory devices. For example, the user may utilize various indicators to adjust polarity, gain, level, pan, tilt, and zoom. The user may also set preferences for each individual display for specific conditions. For example, specific cameras may implement a preferred level of gain in response to a user selecting a combat mode at night.

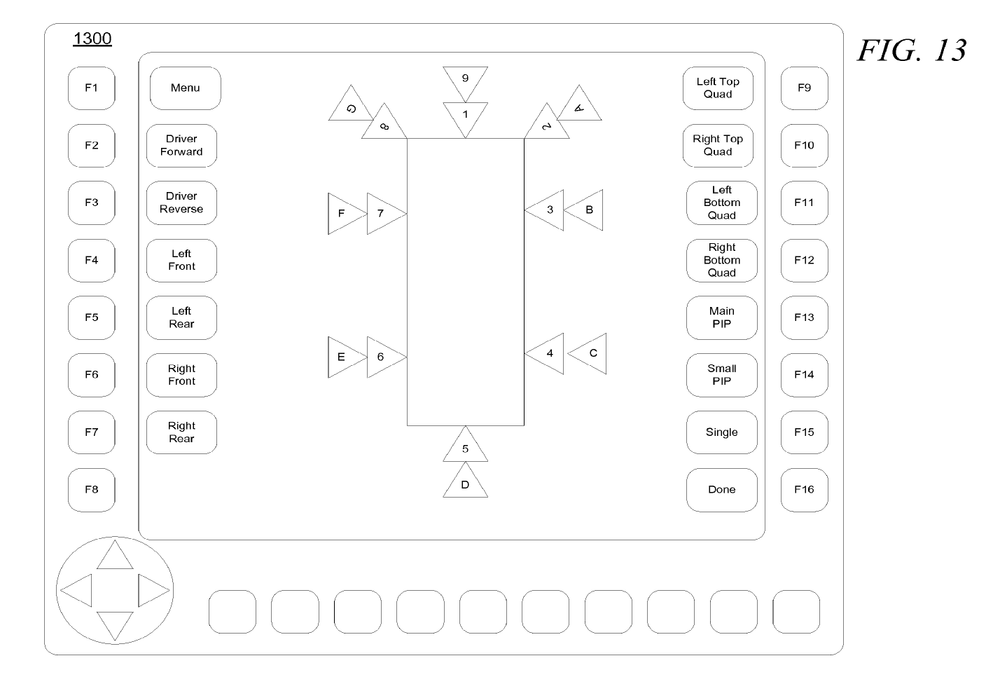

FIG. 13 is a pictorial representation of a VDDS menu for camera selection in accordance with an illustrative embodiment. FIG. 13 illustrates a display 1300 that may be utilized to select cameras and corresponding views. As previously described, the VDDS is unique in the number and types of cameras and inputs that the VDDS may accept. The display 1300 may allow a user to select quadrants, picture-in-picture options, and other information. The cameras utilized may be selected from each display or operational station in the transport vehicle.

The previous detailed description is of a small number of embodiments for implementing the invention and is not intended to be limiting in scope. The following claims set forth a number of the embodiments of the invention disclosed with greater particularity.

What is claimed is:

1. A method for providing situational awareness for a transport vehicle, the method comprising:
receiving a plurality of sensory inputs from cameras positioned about the periphery of the transport vehicle;
processing the plurality of sensory inputs to generate a plurality of processed signals for display to one or more displays;
receiving user input from distinct users specifying one or more views to display on each of the one or more displays as received and processed from the plurality of sensory inputs; and
communicating the plurality of processed signals for displaying the one or more views on each of the one or more displays in response to receiving the user input.

2. The method according to claim 1 wherein the transport vehicle is at least one of a tank, armored vehicle, boat, train, plane, truck, car, weapon, or utility vehicle.

3. The method according to claim 1 wherein the plurality of sensory inputs includes twenty-one inputs.

4. The method according to claim 1 wherein the plurality of outputs include four outputs, wherein the one or more views include up to four views per display.

5. The method according to claim 1 further comprising loading a plurality of images from a memory card inserted in a VDDS of the transport vehicle as if received by the plurality of inputs for simulating traveling and threat conditions within the transport vehicle.

6. The method according to claim 5 wherein the one or more displays concurrently display a distinct selection of the one or more views.

7. The method according to claim 1 wherein each of the one or more displays corresponds to a crew station, and wherein each user selects a quadrant of a display for viewing the one or more views.

8. The method according to claim 1 wherein the plurality of sensory inputs includes all of phase alternating line (PAL) A, PAL B, National Television System Committee (NTSC), RS-343, RS-170, SECAM, RGB resolutions up to XVGA, digital visual format (DVI), video over Internet Protocol (IP), and S video.

9. The method according to claim 1 further comprising communicating a plurality of channels through the VDDS without processing to ensure critical systems in communication with the VDDS receive input in response to a failure of the VDDS.

10. The method according to claim 1 further comprising overlaying data from the transport vehicle including any of global position information, targeting information, or vehicle performance information on the one or more displays.

11. A video and data distribution system (VDDS) for a transport vehicle, the system comprising:
a plurality of input ports operable to receive input signals from a plurality of sensory devices about the periphery of the transport vehicle;
processing logic in communication with the plurality of input ports, the plurality of input ports operable to process the input signals to generate formatted signals displayable to a plurality of displays, the formatted signals including a plurality of views associated with each of the sensory devices;
a user interface in communication with the processing logic, the user interface being utilized by a plurality of users utilizing the plurality of displays to select the plurality of views displayed to each of the plurality of displays and overlay information;
a plurality of output ports in communication with the processing logic, the plurality of output ports being operable to communicate the formatted signals to the plurality of displays; and
a plurality of pass-thru channels operable to communicate data from the one or more of the sensory devices to one or more of the plurality of displays in the event the VDDS fails.

12. The system according to claim 11 further comprising:
a heater operable to heat the system and a chassis of the system to 0 Celsius before the system is powered on and operational; and
a heat sink operable to dissipate heat generated by the components of the system.

13. The system according to claim 11 further comprising a memory card interface operable to receive a memory card, wherein the memory card interface loads a plurality of images from the memory card as if received by the plurality of inputs for simulating traveling conditions and threat conditions within the transport vehicle.

14. The system according to claim 11 wherein the VDDS is operational to withstand a temperature range of −40 to 71 degrees Celsius, submersion in 1.0 meter of water for up to 30 minutes, a 30G shock of 11 milliseconds, and is salt, sand and fungus resistant.

15. The system according to claim 11 wherein the input ports are operable to receive phase alternating line (PAL) A, PAL B, National Television System Committee (NTSC), RS-343, RS-170, SECAM, RGB resolutions up to XVGA, digital visual format (DVI), video over Internet Protocol (IP), and S video.

16. A video and data distribution system (VDDS) for a transport vehicle, the system comprising:
a plurality of input ports operable to receive input signals from a plurality of sensory devices about the periphery of the transport vehicle, the plurality of input ports operable to receive phase alternating line (PAL) A, PAL B, National Television System Committee (NTSC), RS-343, RS-170, SECAM, RGB resolutions up to XVGA, digital visual format (DVI), video over Internet Protocol (IP), and S video;
processing logic operable to process the input signals to generate formatted signals displayable to a plurality of displays;
a plurality of output ports operable to communicate the formatted signals compatible with the plurality of displays, a first user accessing a first of the plurality of displays to select a plurality of views to be displayed on the first of the plurality of displays accessible to the user, a second user accessing a second of the plurality of displays to select a plurality of views to be displayed on the second of the plurality of displays;
a plurality of pass-thru channels operable to communicate information from one or more of the sensory devices to one or more of the plurality of displays in die event the VDDS fails; and
a memory card interface operable to receive a memory card for implementing software configurations of the VDDS and training scenarios in the transport vehicle as if the training scenarios were occurring in real time.

17. The VDDS according to claim 16 further comprising a memory for recording real-time events, wherein the real-time events are utilized to create the training scenarios for utilization by a plurality of transport vehicles, and wherein the training scenarios are uploaded to the VDDS remotely.

18. The VDDS according to claim 16 wherein the processing logic further includes camera controls for adjusting polarity, gain, leveling, tilt, pan, and zoom of the sensory devices for enhancing images captured by the plurality of sensory devices.

19. The VDDS according to claim 16 further comprising a user interface in communication with the processing logic, the user interface being utilized by a plurality of users utilizing the plurality of displays to select the plurality of views displayed to each of the plurality of displays and overlay information, the overlay information including systems of the transport vehicle.

20. The VDDS according to claim 16 wherein the VDDS is operable to receive twenty one inputs from the plurality of sensors and generate four outputs for the plurality of displays, wherein the plurality of views includes four views selectable by the first user and the second user.

21. A method for providing situational awareness for a transport vehicle, the method comprising:
receiving a plurality of sensory inputs from cameras positioned about the periphery of the transport vehicle;
processing the plurality of sensory inputs to generate a plurality of processed signals for display to one or more displays;
receiving user input from a first user specifying one or more views to display on a first of the one or more displays, the one or more views being received and processed from the plurality of sensory inputs;
receiving user input from a second user specifying one or more views to display on a second of the one or more displays, the one or more views being received and processed from the plurality of sensory inputs, the plurality of sensory inputs selected by the first user and the second user being any available view from the sensory inputs; and
communicating the plurality of processed signals for displaying the one or more views on each of the one or more displays in response to receiving the user input.

22. The method of claim 21 wherein the transport vehicle is at least one of a tank, armored vehicle, boat, train, plane, truck, car, weapon, or utility vehicle.

23. The method of claim 21 wherein the plurality of sensory inputs includes twenty-one inputs.

24. The method of claim 21 wherein the plurality of outputs include four outputs, wherein the one or more views include up to four views per display.

25. The method of claim 21 wherein each of the one or more displays corresponds to a crew station, and wherein each user selects a quadrant of a display for viewing the one or more views.
